(19) United States
(12) Patent Application Publication
(10) Pub. No.: US 2006/0047600 A1
(43) Pub. Date: Mar. 2, 2006

(54) Method and system for borrowing base certificate administration

(76) Inventors: Niels Roderick Thomas Bodenheim, Rockville, MD (US); Lynnette Acosta Hernandez, Bethesda, MD (US); Stephen Joseph Walsh, Jacksonville, FL (US); Chad Michael Borst, Chicago, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/924,885

(22) Filed: Aug. 25, 2004

(51) Int. Cl. G06Q 40/00

(52) U.S. Cl. 705/40

(57) ABSTRACT

An embodiment of the present invention relates to borrowing base certificate administration. A method and system may include generating a borrowing base template for a loan wherein the borrowing base template is customized for a user by segmenting the loan into a plurality of schedules and assigning each schedule a corresponding advance rate that is applied to eligible collateral; making the borrowing base template available to the user through an online interface; receiving funding request data from the user through the online interface; and generating a funding request for the user with the borrowing base template.

### FIELD OF THE INVENTION

The present invention relates generally to borrowing base certificate administration, and more specifically to providing an online interface for creating a borrowing base certificate template and facilitating funding requests.

### BACKGROUND OF THE INVENTION

Asset based loans are a common type of loan in which the loan is secured by an asset of the borrower. For example, the borrower may grant the lender a security interest in an asset such as receivables or inventory to secure the loan. The grant of the security interest creates the borrowing base for the loan. Asset based loans are commonly revolving loans (“revolvers”) in which there is no specified repayment schedule and the loan balance may increase and decrease over time. As receivables are paid, the cash is turned over to the lender to pay down the loan balance. When the borrower needs additional working capital, the borrower may request another advance. Asset based loans can optimize the availability of working capital from the borrower's current asset base.

A borrowing base generally includes assets, inventory and/or accounts receivable, which are available as collateral to secure a revolver. The size of the borrowing base may vary with changes in the amount of the borrower's current assets. For example, as the borrower builds or acquires new inventory, or as new receivables are generated from sales, these assets may be covered by the security interest and eligible for inclusion in the borrowing base. A borrowing base certificate generally refers to a form prepared by the borrower that reflects the current status of the borrower's collateral. Borrowing base certificates may be due on a periodic basis, such as daily, weekly or monthly.

Known methods for advancing funding to asset based lending clients use a paper-based manual process, which is error prone, time consuming and disliked by many customers. The paperwork and other information to be processed can be onerous and complicated. In another example, customer information may be processed through a spreadsheet program selected by the customer. Once that information is processed, the information may be submitted to the lender, e.g., a bank or other financial institution. At the lender establishment, the information is generally re-processed (or re-entered) into a system specific to that lender. As a result, various inefficiencies occur thereby leading to higher costs and longer delays for customers and other participants involved in the process. The use of such methods may introduce financial and other risks due to potential lost deals, poor efficiency and customer dissatisfaction.

As various updates and other developments may occur, the information submitted initially may need to be modified. However, current systems fail to provide an easy-to-use, efficient medium for communicating information and updating previously submitted information.

Other drawbacks may also be present.

### BRIEF DESCRIPTION OF THE INVENTION

Accordingly, one aspect of the invention is to address one or more of the drawbacks set forth above.

In one exemplary embodiment of the present invention, a computer implemented method for borrowing base management comprises the steps of: generating a borrowing base template for a loan wherein the borrowing base template is customized for a user by segmenting the loan into a plurality of schedules and assigning each schedule a corresponding advance rate that is applied to eligible collateral; making the borrowing base template accessible to the user through an online interface; receiving funding request data from the user through the online interface; and generating a funding request for the user with the borrowing base template.

In accordance with another exemplary embodiment of the present invention, a computer implemented system for borrowing base management comprises a template module for generating a borrowing base template for a loan wherein the borrowing base template is customized for a user by segmenting the loan into a plurality of schedules and assigning each schedule a corresponding advance rate that is applied to eligible collateral; an online interface for making the borrowing base template accessible to the user and receiving funding request data from the user; and a funding request module for generating a funding request for the user with the borrowing base template.

In accordance with another exemplary embodiment of the present invention, at least one signal is embodied in at least one carrier wave for transmitting a computer program of instructions configured to be readable by at least one processor to execute a computer process for borrowing base management, and the computer process comprises template generating means for generating a borrowing base template for a loan wherein the borrowing base template is customized for a user by segmenting the loan into a plurality of schedules and assigning each schedule a corresponding advance rate that is applied to eligible collateral; means for making the borrowing base template accessible to the user through an online interface; receiving means for receiving funding request data from the user through the online interface; and request generating means for generating a funding request for the user.

### BRIEF DESCRIPTION OF THE DRAWINGS

FIG. 1 is a schematic representation of a system for borrowing base certificate administration, according to an embodiment of the present invention.

FIG. 2 is an exemplary flowchart for processing a borrowing base certificate, according to an embodiment of the present invention.

FIG. 3 is an exemplary flowchart for preparing a borrowing base certificate template, according to an embodiment of the present invention.

FIG. 4 is an exemplary flowchart for defining management tools, according to an embodiment of the present invention.

FIG. 5 is an exemplary flowchart for preparing a funding request, according to an embodiment of the present invention.

FIGS. 6A and 6B are an exemplary interface for displaying a BBC default page, according to an embodiment of the present invention.

FIG. 7 is an exemplary interface for displaying a Schedules page for customizing a BBC template, according to an embodiment of the present invention.

FIG. 8 is an exemplary interface for displaying a Payor Categories page for customizing a BBC template, according to an embodiment of the present invention.

FIG. 9 is an exemplary interface for displaying an Adjustment Fields page for customizing a BBC template, according to an embodiment of the present invention.

FIG. 10 is an exemplary interface for displaying a Reserves/Collateral page for customizing a BBC template, according to an embodiment of the present invention.

FIG. 11 is an exemplary interface for displaying a Limits page for customizing a BBC template, according to an embodiment of the present invention.

FIG. 12 is an exemplary interface for displaying a Representations/Warranties page for customizing a BBC template, according to an embodiment of the present invention.

FIG. 13 is an exemplary interface for displaying a homepage for a funding request, according to an embodiment of the present invention.

FIG. 14 is an exemplary interface for displaying an account balance and activity information page for a funding request, according to an embodiment of the present invention.

FIG. 15 is an exemplary interface for displaying Computation of Collateral page for generating a funding request, according to an embodiment of the present invention.

FIG. 16 is an exemplary interface for displaying Computation of Availability page for generating a funding request, according to an embodiment of the present invention.

FIG. 17 is an exemplary interface for displaying Computation of Loan page for generating a funding request, according to an embodiment of the present invention.

FIG. 18 is an exemplary interface for displaying Representations and Warranties page for generating a funding request, according to an embodiment of the present invention.

### DETAILED DESCRIPTION OF THE INVENTION

A system and process for improving efficiency of managing borrowing base certificates are described. According to one exemplary aspect, the system and process are directed to borrowing base certificate administration. One technical effect of an embodiment of the invention is to provide a system and process for providing an online web interface for borrowing base certificate administration, as set forth in the Brief Description of the Invention, above and as more fully described here in the Detailed Description of the Invention. Various aspects and components of this system and process are described below. The system and process can be used, according to one example, in the context of a lender making loans to healthcare providers, such as doctors and hospitals, where the loans are secured by receivables from a payor such as Medicare and Medicaid. While various embodiments of the present invention are described herein, it is recognized that embodiments of the present invention can apply to other applications as well.

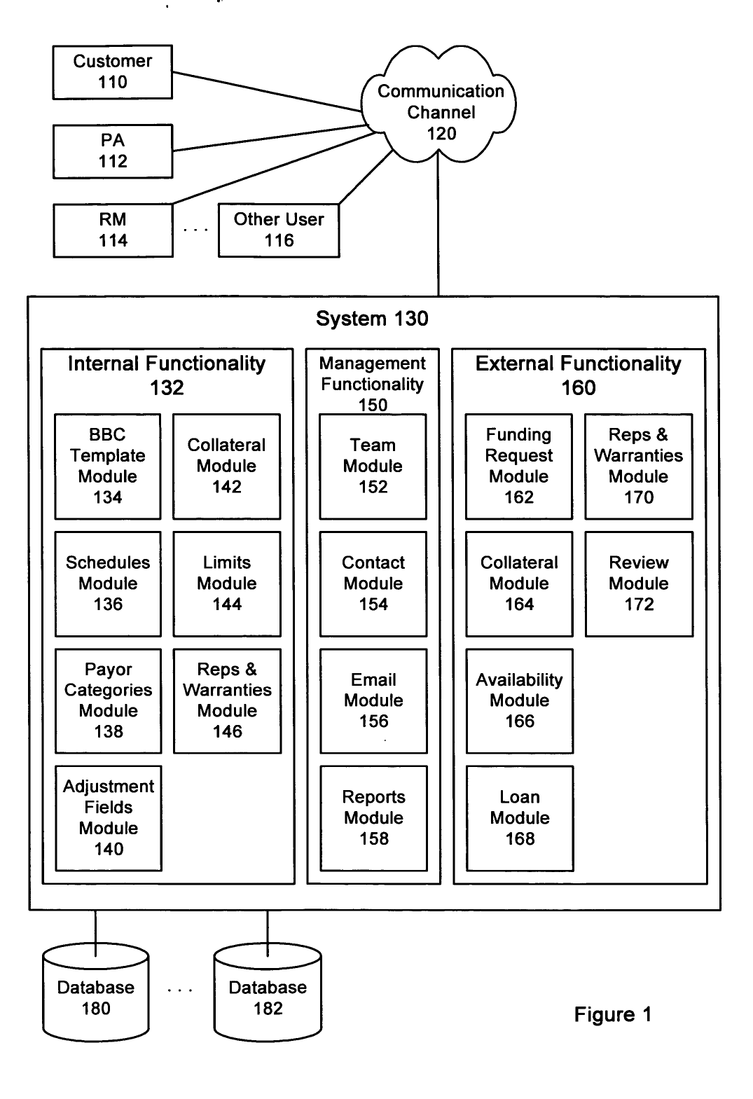

FIG. 1 is a schematic representation of a system for borrowing base certificate administration, according to an embodiment of the present invention. System 130 can enable a user to access, compile, manipulate, and otherwise interact with information regarding one or more borrowing bases for various projects, loans, etc. Users may access System 130 to perform functions associated with borrowing base administration via a communication channel 120, such as the Internet, an Intranet, Ethernet and/or other types of networks. For example, users may include a customer 110, portfolio analyst (PA) 112, relationship manager (RM) 114, and/or other user 116, which may include a borrower, an agent, team leader, executive, loan officer, account manager and/or other user of the system. For example, a loan officer (or other entity) may generate a Borrowing Base Certificate (BBC) template for a customer. A funding request may be generated where a PA may provide a first level of approval and a RM may provide a second level of approval. A team leader may edit and activate various BBC templates. Additional participants may be included based on various applications. An embodiment of the present invention provides request funding, online management reporting, auditors access to client information, client access to account information and/or other functionality.

System 130 may include modules and functions associated with borrowing base administration. System 130 may include Internal functionality 132 as well as External functionality 160. Management functionality 150 may also be provided. Internal functionality 132 may be directed to back-end processing while External functionality 160 may be directed to customer/user interaction. For example, Internal functionality 132 may include BBC Template Module 134, Schedules Module 136, Payor Categories Module 138, Adjustment Fields Module 140, Collateral Module 142, Limits Module 144, Reps & Warranties Module 146 and/or other modules. Management functionality 150 may include Team Module 152, Contact Module 154, Email Module 156, Reports Module 158 and/or other modules. External functionality 160 may include Funding Request Module 162, Collateral Module 164, Availability Module 166, Loan Module 168, Reps & Warranties Module 170, Review Module 172 and/or other modules. The modules may function separately or in various combinations. The modules may be further combined, duplicated and/or separated. While the modules are shown within a single system, the modules may also operate among several systems. Additional functions associated with borrowing base administration may be provided through other modules.

The modules may communicate with a plurality of databases, which may also function collectively or separately. The modules of System 130 may access, retrieve, store and/or otherwise manipulate various information stored in databases 180, 182. In addition, the modules may access other information from external sources and/or other sources of information. Databases 180, 182 may store and organize data associated with various loans, projects, users, etc. Databases 180, 182 may represent various sources of data, which may be located at a common site, which may be local or remote, distributed among several locations, or maintained at other locations and according to different database structures. The data may be input by the user, imported electronically, or otherwise received from a source. For example, automatic loan feeds from internal transaction and accounting systems may be received by System 130. Databases may represent various types of data sources, including the Advanced Commercial Banking System (ACBS), Receivables Tracking System (RTS), etc.

BBC Template Module 134 can create a customized BBC template for a customer such as a borrower. By receiving data from one or more data sources, a new customized BBC template can be created. Once the BBC template is created, funding requests may be easily generated. As discussed in detail below, various fields relating to customization of the BBC template may be input by the RM, PA or other user and/or selected from a list of predetermined options. In addition, the options themselves may be created and/or modified according to an embodiment of the present invention. For example, the RM, PA and/or other entity may modify, add and/or delete possible field selections. The BBC template, once completed, serves as a customized program for administering BBC funding requests. It includes functionality to make various computations that are carried out in generating a funding request for the borrower. It also stores various financial data for each borrower used to make the computations. The BBC template includes an internal interface for use by the lender. The BBC template also includes an external interface for use by the borrower.

The BBC template, once completed, allows the borrower to submit data and initiate a funding request through an online interface in the form of funding request pages. The funding request pages guide the user through the steps of inputting necessary data and calculating various values relating to, among other things, eligible collateral, availability and loan balance. For example, according to one embodiment, and as described in detail below, the BBC template includes functionality to take the borrower through a computation of collateral step, a computation of availability step, and a computation of loan step. The computation of collateral step performs various calculations and adjustments to determine a value for “total eligible accounts,” which represents collateral that may be used to secure the loan. The computation of availability step takes the value for total eligible accounts and makes various calculations relating to reserves and collateral and an advance rate to arrive at the “net availability,” which represents the amount that can be loaned to the borrower. The computation of loan step calculates the new loan balance and the remaining availability after the loan has been made.

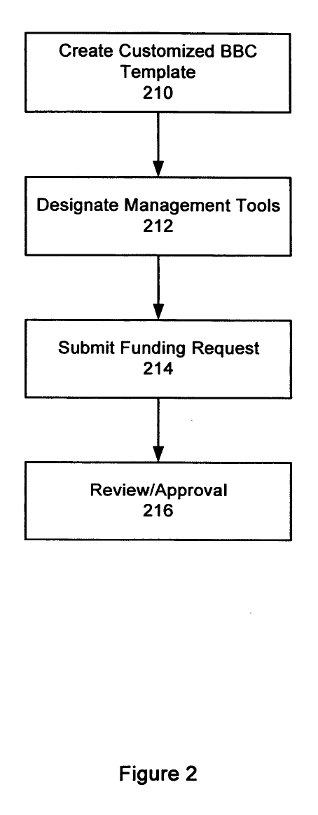

Referring again to FIG. 2, Schedules Module 136 may identify schedule information for the BBC template. The term “schedule” generally refers to a subcategory of a loan. Each schedule may have one or more associated payors. Schedules may be defined by regions, accounts receivable systems, nursing homes, hospitals, etc. Each schedule may be assigned a corresponding advance rate (as a percentage or other portion). The advance rate generally refers to the percentage of funds extended to a borrower against eligible collateral as stated in a lending contract, or the percentage of the current borrowing base that a lender can make available to the borrower as a loan. The advance rate may be used in the computation of net availability. In particular, the net availability for the borrower may be calculated by multiplying the eligible collateral (also referred to as “net eligible accounts”) by the advance rate. By segmenting the loan into a plurality of schedules and allowing the lender to assign individual advance rates for each schedule, loans may be managed for risks and/or other considerations.

Payor Categories Module 138 may identify one or more payor categories within each schedule. Exemplary payor categories may include Medicaid, Medicare, Commercial, Contract Receivable and/or other categories.

Adjustment Fields Module 140 may identify one or more adjustment fields for each payor category of a particular schedule. Adjustment fields can be used to make various adjustments during the computation of collateral step in generating a finding request for a borrower. Adjustment fields may impact the total eligible accounts and hence the net availability. Exemplary adjustment fields may be included that relate to cross-aging, unbilled-calculations, credit balance reserve, private pay/applied income, concentration, billed account balance, cost-settlement reserve, unposted cash, liquidity factor, ineligible accounts, and rollup adjustment. These adjustment fields may be used to make adjustments that impact the total eligible accounts. Cross-aging generally refers to the situation where past due receivables exceed a given percentage of the borrower's total accounts receivable, in which case an adjustment may be made to make certain accounts receivable ineligible as collateral. Unbilled calculation refers to the situation where a customer cannot produce daily agings to identify their up to date, all-inclusive accounts receivable. Therefore they produce reports that estimate how much revenue they have potentially generated since the last aging. Credit balances represent an overpayment by a particular payor. Private pay typically refers to a situation where the account or any portion of the account is payable by a person or individual other than the payors listed as qualified accounts in the loan and security agreement. Concentration refers to the percentage or amount of a payor category that is associated with a certain payor. Billed accounts typically refers to qualified accounts of the borrower generated in the ordinary course of the borrower's business from the rendition of approved goods or services which the lender deems to be a qualified account. Cost settlement generally refers to liabilities that may impact a lender if there are liabilities due to government payors, as the government may withhold funds that the lender is entitled to. Unposted cash generally refers to cash collected by the borrower which has not reduced the accounts receivable at the time a funding request is created.

Liquidity factor and ineligible account data may also be specified. For example, a lender, in its discretion, may further adjust the borrowing base by applying percentages, such as liquidity factors, to qualified accounts by payor class (or other category) based on a borrower's actual recent collection history for each such payor class (e.g., Medicare, Medicaid, commercial insurance, etc.) in a manner consistent with the lender's underwriting practices and procedures. The liquidity factor may be, for example, a percentage that is multiplied by eligible accounts to calculate total eligible accounts. Such liquidity factors may be adjusted by the lender from time to time as warranted by the lender's underwriting practices, procedures, discretion and/or other circumstance. Ineligible accounts typically refers to accounts that remain unpaid more than the period specified as eligible accounts in the loan and security agreement.

Collateral Module 142 may identify reserves and/or collateral for limiting and/or increasing a customer's availability during the computation of availability step. Reserves and/or collateral may be applied at the schedule level. The term “reserves” generally refers to an amount or percentage that is applied in the computation of availability step to reduce a borrower's total eligible accounts. “Collateral” generally refers to an amount or percentage that is applied in the computation of availability step to increase the borrower's total eligible accounts. The Collateral Module 142 may also include an over-availability functionality that may allow a customer to borrow above the collateral value. Over-availability generally refers to a loan over and above the available collateral base that is made available to a borrower on an exception basis, which may involve formal approval. Other reserves and/or collateral for limiting and/or increasing availability may be specified and applied.

Limits Module 144 may apply one or more limit amounts for risk management purposes as stated in a lending contract, or otherwise agreed upon. For each schedule, a limit amount and description may be applied. Various types of limits may be applied. As will be described further below, the limit amounts may be applied to various calculations made in generating a funding request. For example, various limit amounts may be applied in the computation of collateral step, the computation of availability step, and the computation of loan step. Limit amounts may be applied, for example, to limit total eligible accounts, to limit various adjustment fields, and/or to limit one or more reserves or collateral values.

Reps & Warranties Module 146 may identify appropriate representations and warranties. The RM, PA, or other user may select certain representations and warranties to be displayed to the borrower in the funding request pages. Specific loan information may also be included.

A user such as an RM or a PA may personalize BBC administration through various management features. Management functionality 150 may include Team Module 152, Contact Module 154, Email Module 156, Reports Module 158 and/or other modules. Team Module 152 may identify a team leader, one or more relationship managers, one or more portfolio analysts and/or other team members.

Contact Module 154 may identify customer information including name, address and/or other identification data. Contact information may identify data associated with a contact individual, which may include name, job title, email, phone, fax, mobile number, etc. A list of loans as well as role information may be identified as well.

Email Module 156 may identify triggering events for prompting a notification, such as an email notification. Other types of notifications may be applied as well, such as telephone call, mobile phone call and/or other type of contact. Exemplary BBC triggering events may include when a new BBC template has been set up, when a BBC template is shared with the customer(s), when the BBC template is activated, when the BBC template is deactivated and/or other triggering events. Exemplary Funding triggering events may include when the customer has submitted a funding request to the lender, when the funding is sent by the PA for approval, when the funding is approved, when the funding is rejected and/or other triggering events. Also, different notifications may be sent based on the type of triggering events. For example, submitted funding requests may be assigned an email notification while funding rejections may be assigned a phone call. Notification formats may also be specified (e.g., HTML format, text format, voice file, etc.) as well as the amount of detail forwarded in the notification.

Reports Module 158 may generate various types of reports, which may include a trending report, loan statement, loan activity statement, loan transaction report, loan facility statement, BBC trending graph, monthly (or other period) statement package and/or other reports. Reports may be customized by the customer according to various specifics, filters and/or other user inputs. Reports Module 158 may provide various reporting tools including but not limited to loan balancing details, trending analysis, etc. For example, a trending report may display collateral, availability, loan details and/or other data over a selected period of time. In addition, a graphing report may display a line chart (or other type of chart) of collateral, availability, loan data and/or other data, according to selected criteria.

External functionality 160 may include a Funding Request Module 162, Collateral Module 164, Availability Module 166, Loan Module 168, Reps & Warranties Module 170, Review Module 172 and/or other modules. Funding Request Module 162 may prepare a request for funding for a customer (e.g., borrower) based on the BBC template created with the BBC Template Module 134. Various computations may be performed in generating a funding request, as discussed below. In addition, various attachments, including documentation, may be attached to a funding request. Exemplary attachments may include a summary of account receivables, credit balance reports, census reports, and/or other supporting documents. Attachments may be in PDF format, an electronic document, and/or other type of attachment.

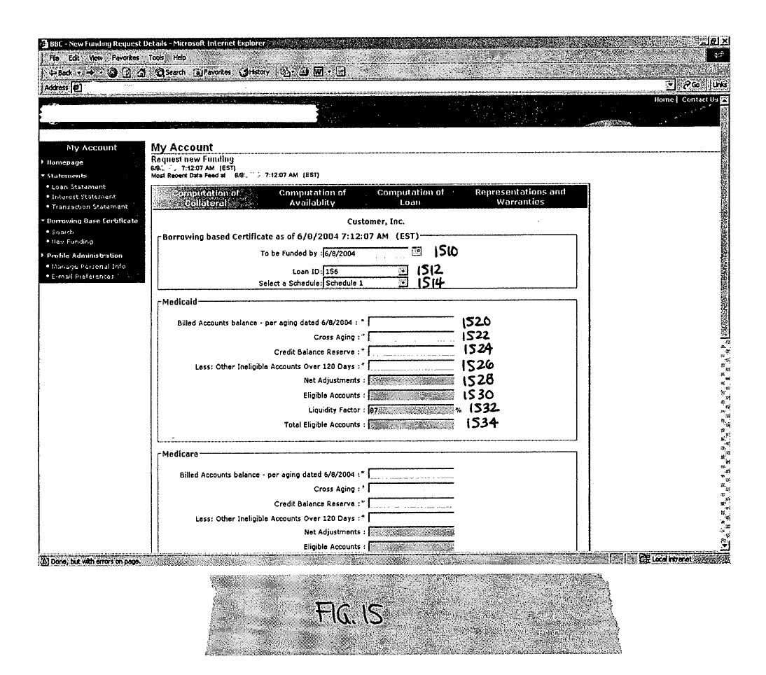

Collateral Module 164 may compute collateral data such as total eligible accounts during the computation of collateral step in the funding request. Collateral computations may involve generating a value for total eligible accounts for each payor category. As described below and as shown in FIG. 15, the collateral computations may be based on net adjustments, eligible accounts, and a liquidity factor, as well as other considerations. Computation of collateral may refer to a summation of a borrower's collateral through schedules, payor categories, adjustments, limits and/or other considerations.

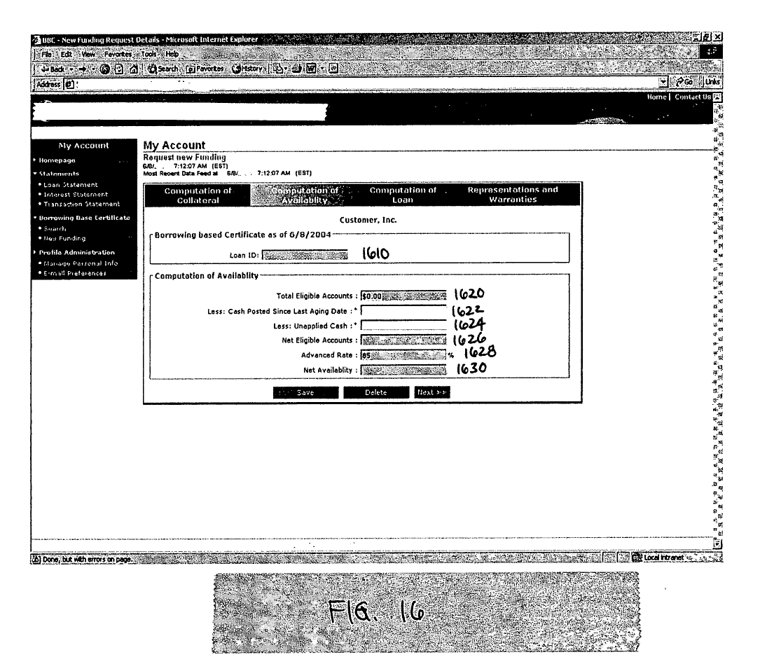

Availability Module 166 may compute availability data such as net availability during the computation of availability step in the funding request. As described below and as shown in FIG. 16, a net availability calculation may be based on net eligible accounts and an advance rate, as well as other considerations. The computation of availability step may include the summation of various schedules where an advance rate may be applied after or before additional reserves, collateral, and/or un-posted cash adjustments (including other considerations and/or adjustments) are made to the summation where the end result may be referred to as net availability.

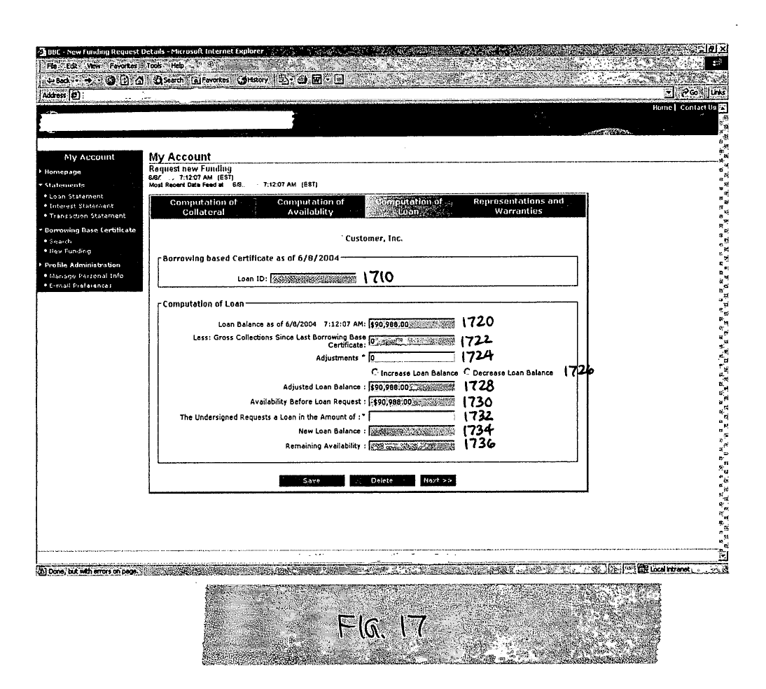

Loan Module 168 may compute loan data, such as a loan balance and a remaining availability, for the funding request. As described below and as shown in FIG. 17, the loan calculation may consider adjustments in calculating a loan balance and remaining availability. Computation of the loan data may determine a client's borrowing availability and/or funding request based on the loan balance and computation of availability. Other factors may be considered.

Reps & Warranties Module 170 may identify and display appropriate representations and warranties. For example, various legal clauses may be displayed, based on user preference, specific applications and/or other considerations. In addition, specific loan information (e.g., contact information, lender information, loan agreement data, etc.) may also be included.

Review Module 172 provides a review process, which may be performed by various participants, including the PA and RM. Other reviewing entities may participate as well.

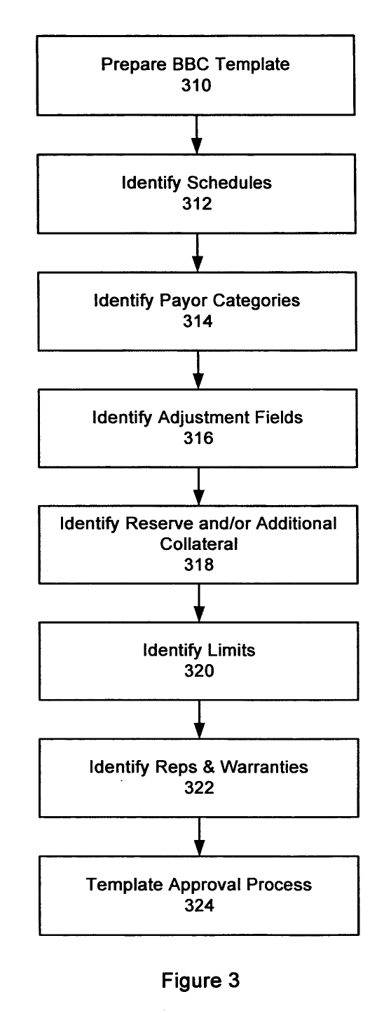

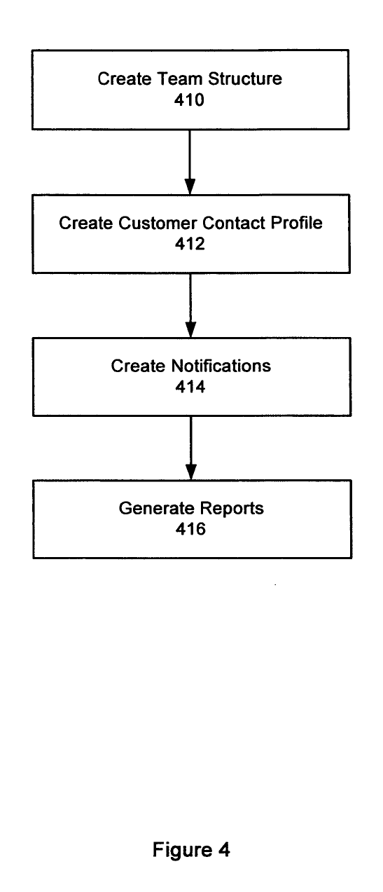

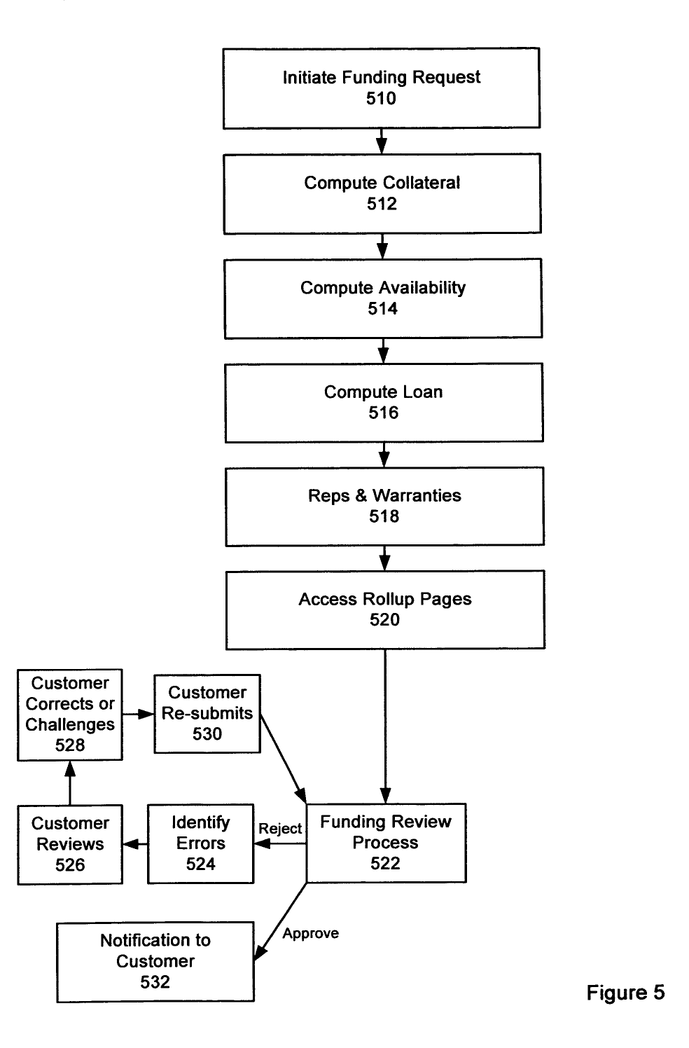

FIG. 2 is an exemplary flowchart depicting the overall processing of a borrowing base certificate, according to an embodiment of the present invention. At step 210, a user, such as an RM, may create a customized BBC template for a customer, such as a borrower. At step 212, various management tools may be designated for use in the BBC processing. At step 214, a funding request may be submitted for approval. At step 216, as part of the review and approval process, a PA and/or RM may review the funding request. If the funding request is rejected, the PA and/or RM may identify various errors and provide comments where applicable. The customer may then review the errors and comments. In response, the customer may make corrections where appropriate or challenge the errors. The customer may resubmit the funding request. If the PA and the RM approve the funding request, a notification may be sent to the customer. The process of creating a customized BBC template shown in box 210 is described in more detail in connection with FIG. 3. The designation of management tools depicted in box 212 is shown in more detail in FIG. 4. The submission of a funding request and review and approval boxes 214 and 216 are shown in more detail in FIG. 5. While the process illustrated in FIG. 2 discloses certain steps performed in a particular order, it should be understood that the present invention may be practiced by adding one or more steps to the process, omitting steps within the process and/or altering the order in which one or more steps are performed.

FIG. 3 is an exemplary flowchart for preparing a borrowing base certificate template, according to an embodiment of the present invention. An embodiment of the present invention is directed to creating a customized BBC template for a specified customer (or group of customers). At step 310, preparation of a BBC template may be initiated. At step 312, schedules may be defined. At step 314, payor categories may be identified. At step 316, adjustment fields may be specified. At step 318, reserve and/or additional collateral may be identified. At step 320, limits may be defined. At step 322, representations and/or warranties may be selected. At step 324, a template approval process may be conducted. While the process illustrated in FIG. 3 discloses certain steps performed in a particular order, it should be understood that the present invention may be practiced by adding one or more steps to the process, omitting steps within the process and/or altering the order in which one or more steps are performed.

During an underwriting process, a borrower's availability structure may be determined through negotiations, through the representations from the borrower to the lender of the collateral base, and/or other process. The BBC template may be prepared by a PA, RM, or other individual, based on the set forth criteria in addition to qualified accounts, adjustments, reserves, advance rates and/or other criteria that may be referenced in the loan contract.

At step 310, preparation of a BBC template may be initiated. After the nightly feed of a tracking system such as the Receivables Tracking System (RTS) nightly feed, any new customers added to the BBC database should be available for BBC setup. An email or other notification may be sent to an RM/PA who supports the customer informing the RM/PA that a new customer is available for set-up on the BBC application. The RM/PA may access a screen to search for new customers pertaining to the RM/PA.

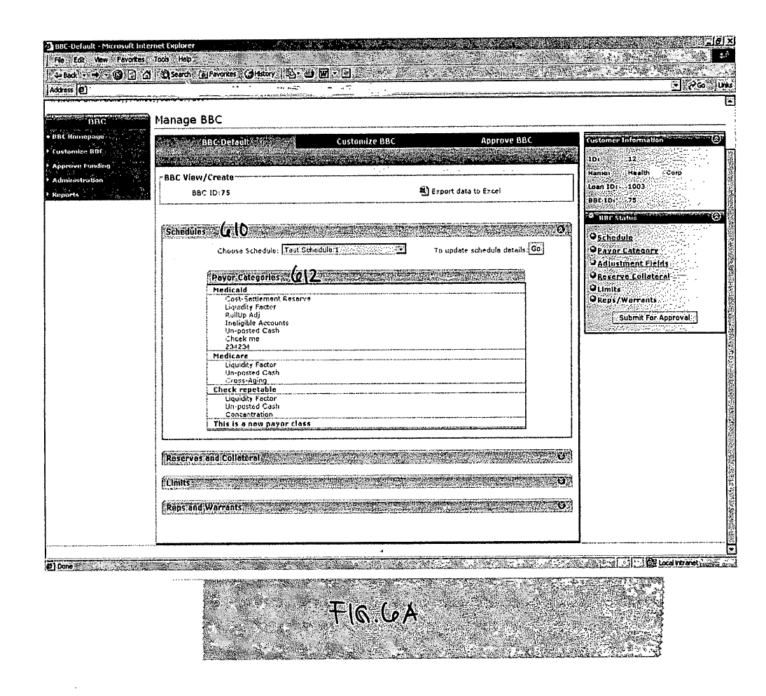

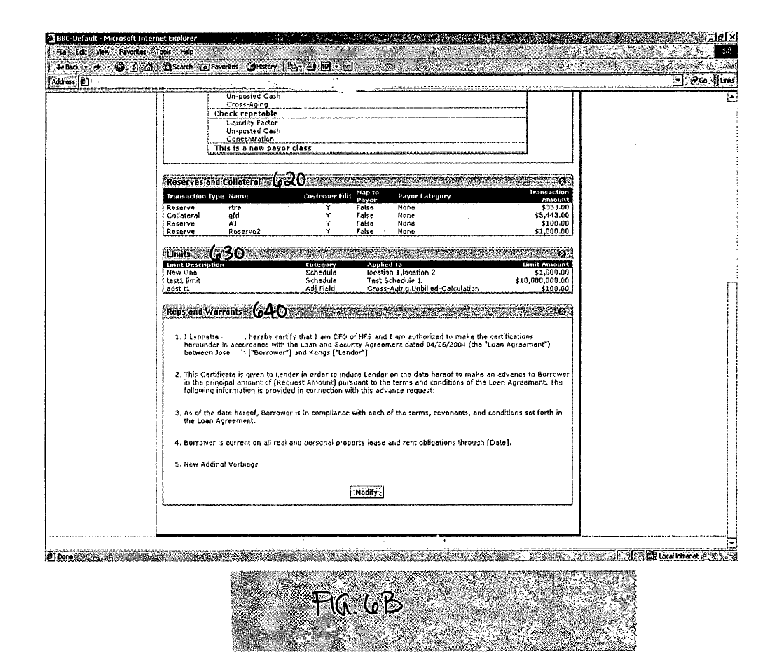

FIGS. 6A and 6B are an exemplary interface for displaying a BBC default page, according to an embodiment of the present invention. As shown in FIGS. 6A and 6B, Schedules 610, Payor Categories 612 for each Schedule, Reserves and Collateral 620, Limits 630, and Representations and Warranties 640 may be displayed by selecting a BBC Default Tab.

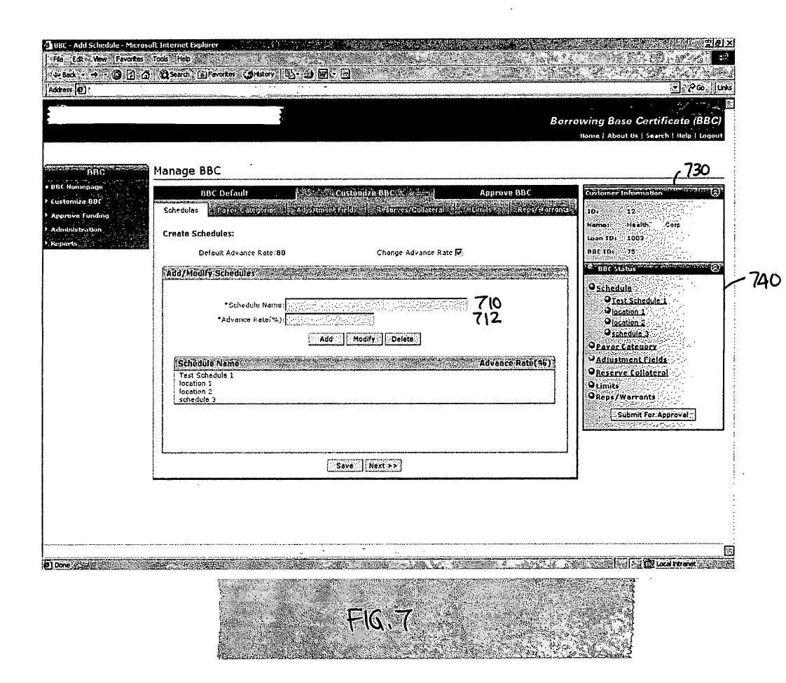

At step 312, schedules may be identified. Each customer may have multiple schedules where each schedule may have multiple payor categories. FIG. 7 is an exemplary interface for displaying a Schedules page for customizing a BBC template, according to an embodiment of the present invention. Schedules identified by Schedule Name 710 may be created, added and/or modified. An advance rate 712 may be associated with each schedule where the advance rate represents a percentage of funds extended to a client against eligible collateral as stated in a lending contract. Advance rate may refer to the maximum percentage of the current borrowing base that a lender can make available to the borrower as a loan. A customer information pane 730 and BBC status pane 740 may also be provided. Customer information pane 730 may provide loan and BBC identification data. BBC status pane 740 may provide status data, including whether data input has been started, partially completed, completed, etc., as indicated by color-coded symbols, for example. Further, the BBC status pane may be specified during the template creation process.

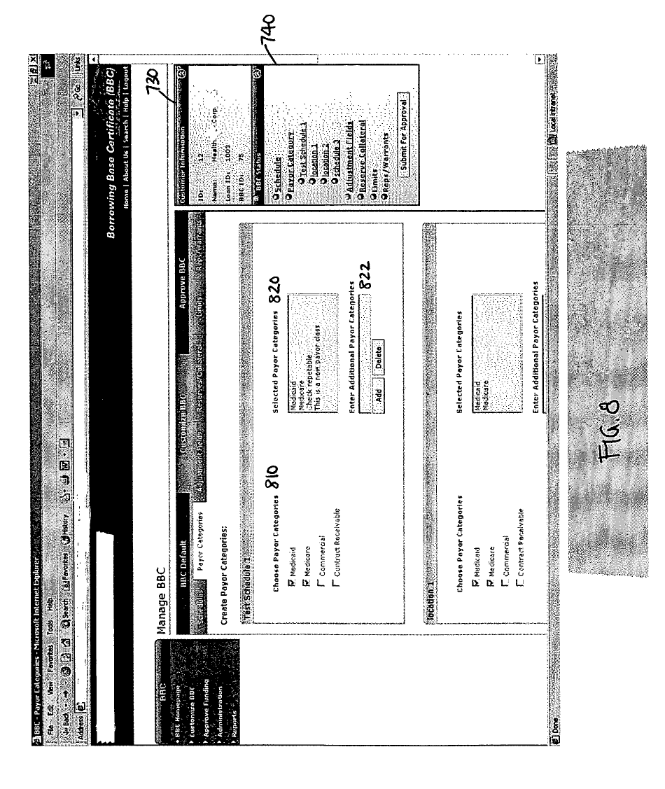

At step 314, payor categories may be identified. Each customer may have multiple schedules and each schedule may have multiple payor categories. FIG. 8 is an exemplary interface for displaying a Payor Categories page for customizing a BBC template, according to an embodiment of the present invention. Various payor categories may be created for each schedule. In the exemplary embodiment of FIG. 8, payor categories may include Medicaid, Medicare, Commercial, and Contract Receivable. Selected payor categories may appear in 820 for the appropriate schedule. Additional payor categories may be entered, at 822.

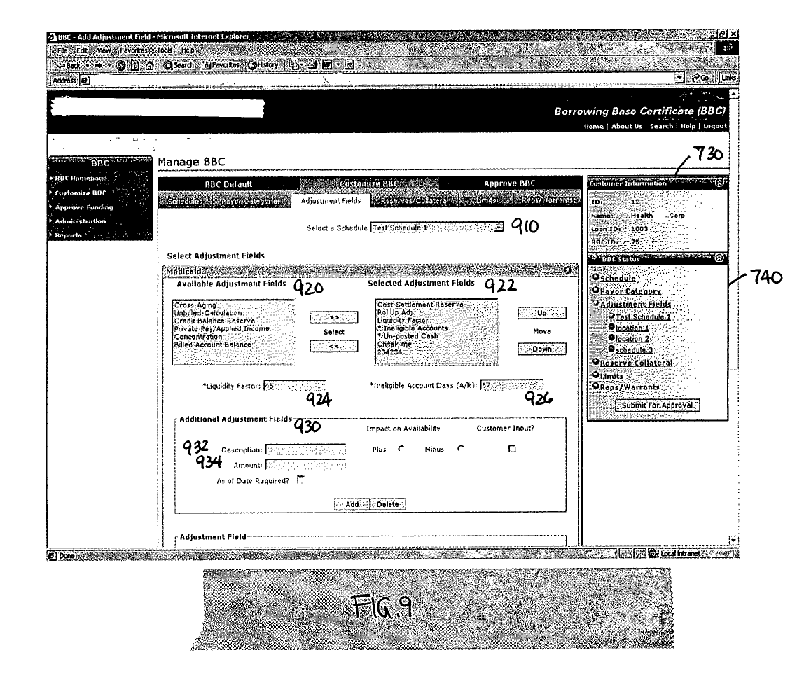

At step 316, adjustment fields may be specified. Each customer may have a unique combination of adjustment fields in their BBC template. The adjustment fields and/or liquidity factor indicated may be specific to the combination of schedule and payor categories selected. For example, each schedule/payor category combination may have multiple adjustment fields. FIG. 9 is an exemplary interface for displaying an Adjustment Fields page for customizing a BBC template, according to an embodiment of the present invention. Adjustment fields may be designated for each payor category. Exemplary adjustment fields may include cross-aging, unbilled-calculation, credit balance reserve, private pay/applied income, concentration, billed account balance, cost-settlement reserve, rollup adjustment, liquidity factor, ineligible accounts, un-posted cash and/or other adjustment fields. Adjustments may be predetermined or require customer input and/or other data where adjustments may have positive or negative impact on availability. Available adjustment fields may be displayed in 920 and selected adjustment fields may be displayed in 922. Liquidity factor 924 and ineligible account days 926 may also be specified. Ineligible account days generally refers to the number of days after which an account becomes ineligible collateral. Additional adjustment fields 930 may also be specified by entering a description 932, amount 934 and/or other data.

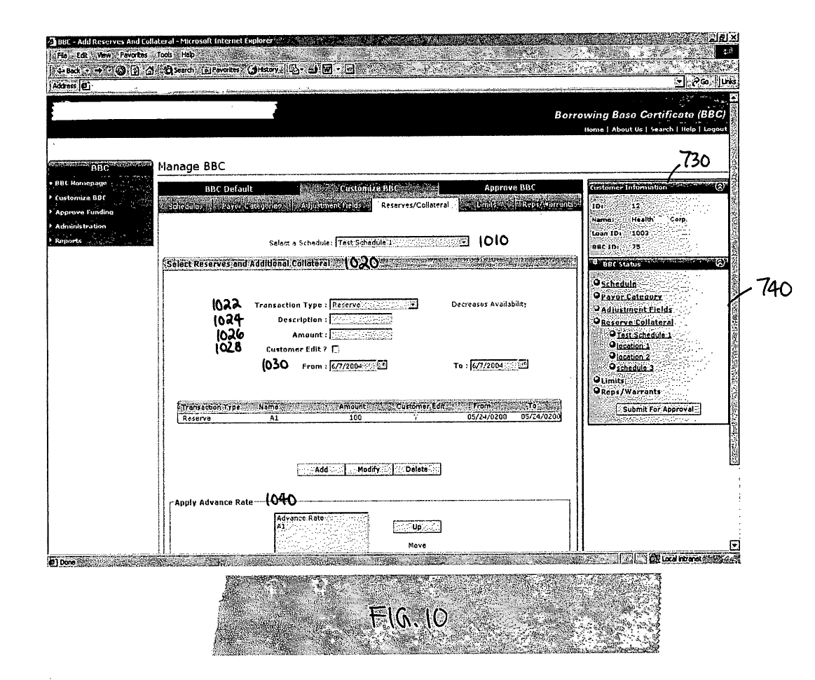

At step 318, reserves and/or additional collateral information may be identified. Reserves and/or additional collateral information may be assigned to the customer and may be independent of the schedules and/or payor categories of a customer. A reserve generally refers to an amount or percentage that is applied in the computation of availability step to reduce a borrower's total eligible accounts. Collateral generally refers to an amount or percentage that is applied in the computation of availability step to increase the borrower's total eligible accounts. Reserves may refer, for example, to a balance of an invoice in excess of the advance where the reserve becomes equity when the invoice is paid. Collateral may refer, for example, to security offered by a client to obtain a loan and may include, for example, inventory, accounts receivable, equipment, securities, real estate, and/or other assets. FIG. 10 is an exemplary interface for displaying a Reserves/Collateral page for customizing a BBC template, according to an embodiment of the present invention. Reserves/collateral data may limit or increase a customer's availability at a schedule level. As shown in the exemplary embodiment of FIG. 10, a schedule may be selected at 1010 and reserve/collateral data 1020, which may include transaction type 1022, description 1024, amount 1026, customer edit 1028, time frame 1030 and/or other data, may be specified. An advance rate 1040 may be applied, as well. In addition, over-availability may be specified.

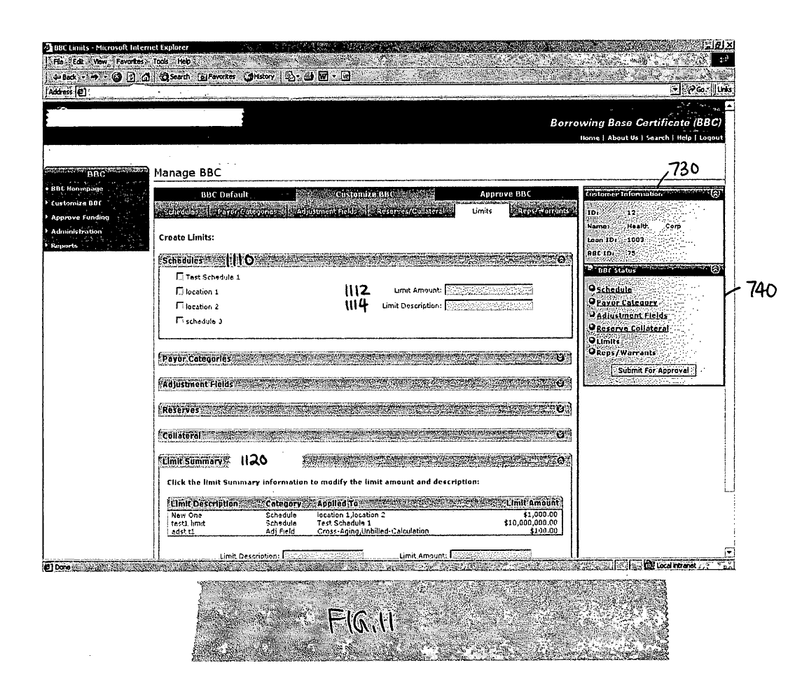

At step 320, limits may be identified for each schedule. Limits may refer to dollar amount limits. FIG. 11 is an exemplary interface for displaying a Limits page for customizing a BBC template, according to an embodiment of the present invention. To create a limit, a schedule may be identified 1110 and limit data, which may include limit amount 1112 and limit description 1114, may be entered. A limit summary may be displayed at 1120. Limits may also be set for payors, adjustments, reserves, collateral, etc.

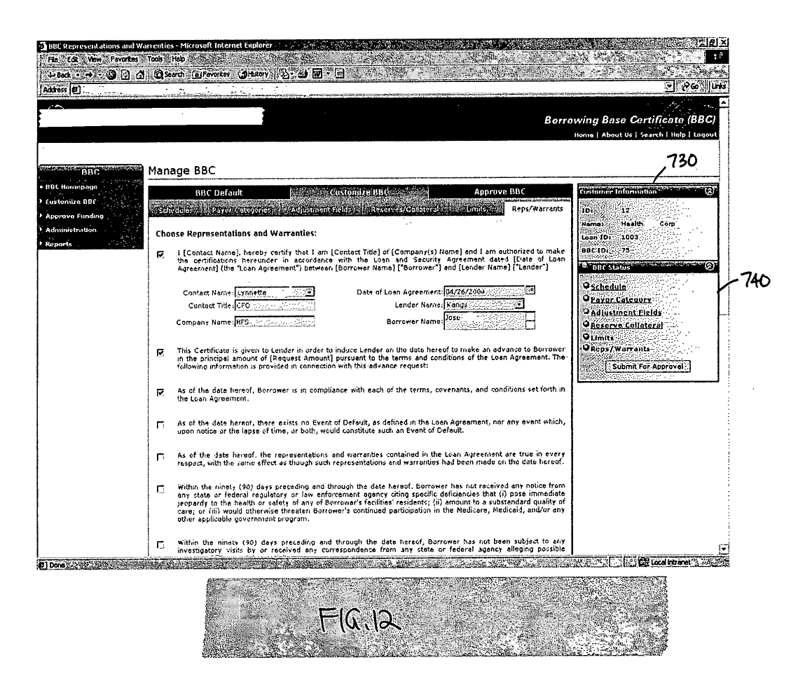

At step 322, representations and/or warranties may be identified. The RM/PA may select legal clauses to appear on the customer's online funding request pages. FIG. 12 is an exemplary interface for displaying a Representations/Warranties page for customizing a BBC template, according to an embodiment of the present invention. Various clauses may be selected according to specific applications. Data specific to a particular BBC template may also be specified, such as contact name, contact title, company name, date of loan agreement, lender name, borrower name, etc. Additional clauses may be created, if desired.

At step 324, a BBC template approval process may be applied. Prior to approval of funding requests, the template may need approval from an individual, such as the RM. A BBC template may be distributed to a borrower when the lender receives electronic signature documents or other authorization. For example, a BBC template may be shared with the customer in a read only mode, a BBC template may be active when an RM allows the customer to create new funding requests, a BBC template may be inactive when an RM prevents the customer from creating new funding requests, a template may be rejected for changes modified by a preparer (e.g., PA) where the status may be synonymous to deactivate, etc. BBC template approval may occur at the beginning of the loan process. According to another example, the template approval process may involve computing collateral, computing availability, computing loan data, identifying legal clauses, and approval/rejection funding decisions.

FIG. 4 is an exemplary flowchart for defining management tools, according to an embodiment of the present invention. FIG. 4 corresponds to box 212 in FIG. 2. At step 410, a team structure may be created. At step 412, a customer contact profile may be created. At step 414, notifications may be created. At step 416, various reports may be generated. While the process illustrated in FIG. 4 discloses certain steps performed in a particular order, it should be understood that the present invention may be practiced by adding one or more steps to the process, omitting steps within the process and/or altering the order in which one or more steps are performed.

FIG. 5 is an exemplary flowchart for preparing a funding request, according to an embodiment of the present invention. A customer may prepare a funding request through the system 130 according to an embodiment of the present invention for submission to the lender for approval. At step 510, a funding request may be initiated. At step 512, collateral may be computed. At step 514, availability may be computed. At step 516, loan data may be computed. At step 518, representations and/or warranties may be displayed to the borrower for completion and acceptance. At step 520, rollup pages may be accessed. At step 522, an approval process may be applied. While the process illustrated in FIG. 5 discloses certain steps performed in a particular order, it should be understood that the present invention may be practiced by adding one or more steps to the process, omitting steps within the process and/or altering the order in which one or more steps are performed.

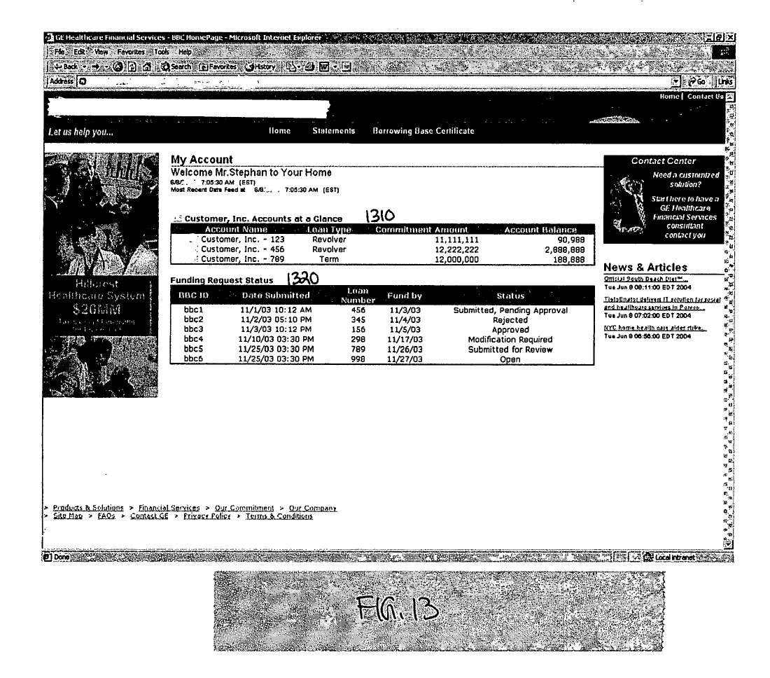

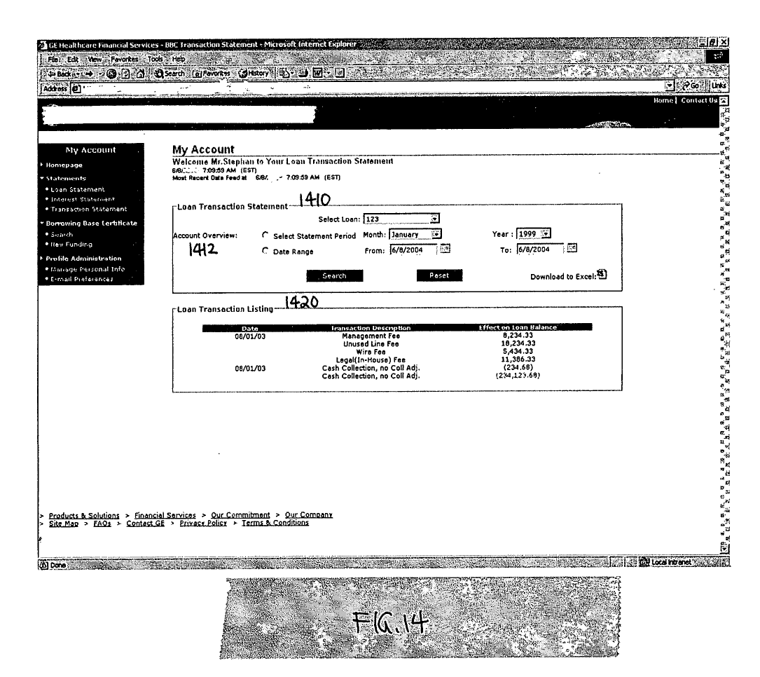

At step 510, a funding request may be initiated. Customers may have on-line access to a customized BBC template, as discussed in connection with FIG. 3. Data from the customized BBC template may be imported into the funding request pages to pre-populate certain fields. The funding request pages may also be populated with values that have been calculated by the calculation functions of the BBC template. FIG. 13 is an exemplary interface for displaying a homepage for a funding request, according to an embodiment of the present invention. As shown in FIG. 13, customer account information 1310 may be provided, which may include account name, loan type (e.g., revolver, term, etc.), commitment amount, account balance, and/or other data. Funding request status data 1320 may also be provided, which may include a BBC identifier, date submitted, loan number, fund by date, status (e.g., submitted, pending approval, rejected, approved, modification required, submitted for review, open, etc.) and/or other data. FIG. 14 is an exemplary interface for displaying an account page for a funding request, according to an embodiment of the present invention. Account data may include loan transaction statement 1410, loan transaction listing 1420 and/or other loan data. For loan transaction statement 1410, account overview data 1412 may be displayed for a selected loan.

Step 512 comprises a computation of collateral step, in which a value for total eligible accounts may be calculated. FIG. 15 is an exemplary interface for displaying a Computation of Collateral page for generating a funding request, according to an embodiment of the present invention. As shown in FIG. 15, a customer may enter data used for computation of total eligible accounts, such as billed accounts balance, cross aging, credit balance reserve, and ineligible accounts. A value for total eligible accounts may then be calculated for each payor category, within each schedule. Funding request data may be displayed for an entity making the funding request, as shown by Customer, Inc. A funding date 1510 represents the date by which the request is to be processed. Loan identifier 1512 identifies the loan for which funding is requested. In addition, a specific schedule 1514 associated with the loan may be selected. Additional fields for billed accounts balance 1520, cross aging 1522, credit balance reserve 1524 and other ineligible accounts 1526 may also be provided to allow the customer to input the appropriate values through the online interface. These fields, and others, can specified by the RM or PA as part of the BBC template setup process. An embodiment of the present invention may perform computations, such as net adjustments 1528, eligible accounts 1530 and total eligible accounts 1534. Liquidity factor 1532 may be imported from the customized BBC template. Each payor category may have a specific liquidity factor set up by the RM (or other source) in the computation of collateral page. A liquidity factor may be located anywhere between or after the adjustment fields. Depending on the application as well as data submitted and computational functions specified when customizing the BBC template, other data may be pre-populated and calculated.

At step 514, availability, e.g., a net availability, may be computed based on data provided by the borrower. A funding request may have one or more computations of availability based on how the advance rate is set up by the lender in a customized BBC template. If the BBC template has only one advance rate, the funding request will only have one computation of availability. If the BBC template has multiple advance rates (e.g., one for every schedule), the funding request will have multiple computations of availability (e.g., one for every schedule). When multiple computations of availability exist, a computation of availability rollup view may be created, as detailed below. FIG. 16 is an exemplary interface for displaying a Computation of Availability page for generating a funding request, according to an embodiment of the present invention. The loan identifier 1610 of the loan for the funding request may be displayed. This is typically the loan that was selected under the Computation of Collateral page. Total eligible accounts 1620 may be displayed, which is typically the same as the total eligible accounts 1534 value for some or all payors and schedules of FIG. 15. There may be instances where this value will not equal the summation of the individual total eligible accounts for the payors due to a reserve mapped to multiple payors or other circumstance. A customer may input a dollar amount for cash posted (e.g., Less: Cash Posted Since Last Aging date) at 1622, unapplied cash (e.g., Less: Unapplied cash) at 1624 and/or other amounts. Reserves and/or collaterals may be applied before and/or after the advance rate. Net eligible accounts 1626 may be calculated, which may include subtracting cash posted, unapplied cash and any reserve amounts from the total eligible accounts value, where collateral may be added. Advance rate 1628 may be fed from the Advanced Commercial Banking System (ACBS), the customized BBC template, and/or other source of data. Net availability 1630 may be calculated, which may include multiplying net eligible accounts 1626 by the advanced rate 1628, where reserve values may be subtracted and collateral values may be added. In some instances, the advance rate may be applied before some (or all) additional reserves and/or collateral fields.

According to another exemplary embodiment, multiple computations of availability may be performed for multiple advance rates. A schedule may be selected for computation of availability. When a schedule is selected, appropriate fields may be pre-populated with the data entered in a previous funding request submitted. Net availability values may be calculated, as discussed above, for each schedule.

There are multiple options for applying reserves in a BBC template, which may be based on the selections made by the lender in the Reserves and Additional Collateral Page of the BBC template setup, for example. Independently of where a reserve is applied, it may be subtracted in a formula to calculate total eligible accounts. For example, when one computation of availability exists in a BBC template, a reserve may be applied before or after an advance rate. A BBC template may have reserves both before and after the advance rate at the same time. In another example, when multiple computations of availability exist in a BBC template, a reserve may be applied before or after an advance rate just like it would when only one advance rate exists. A difference may be that the reserve is tied to one particular schedule's computation of availability. In yet another example, a reserve may be mapped to one or more schedules in the computation of availability step. Once mapped to one or more schedules, a reserve may be applied before or after the advance rate.

There are multiple options for applying collateral in a BBC template, which may be based on the selections made by the lender in the Reserves and Additional Collateral page of the BBC template setup, for example. A collateral value may be located in the Computation of Availability area and, unlike the reserves, it is generally not mapped to a payor. Independently of where a collateral is located, it may be added in a formula to calculate total eligible accounts. For example, when one computation of availability exists, the collateral may be before or after the advance rate. In another example, a collateral may be mapped to one or more schedules in the Computation of Availability step. Once mapped to one or all schedules, it may be applied before or after the advance rate. According to one example, collateral is generally not mapped to any other number of schedules.

Limits in the Computation of Collateral may be applied in various situations. A schedule limit may limit the total eligible accounts for that schedule. If a limit for a schedule exists, the total eligible accounts amount for that schedule may not be greater than the limit. All the limits for schedules may represent a maximum amount the total eligible accounts amount may be. Generally, the lesser of a limit or the total eligible accounts amount may be applied in a schedule. To display the limit for a schedule may involve a footnote (or other symbol) in the Computation of Collateral page of the BBC template. A rollup option may be provided in the schedules dropdown for a schedule limit. Limits may be applied to an individual schedule or the rollup. In either case, the limit will typically affect the total eligible accounts for the schedule(s). The summation of the total eligible accounts for the schedule in the limit cannot be higher than the limit amount. To display the limit of a schedule, a footnote (or other symbol) may be included in the Computation of Collateral page of the BBC template. The actual value of the total eligible accounts may be displayed in that field even if a limit is applied. When applicable, the limit amount may be used in the calculation of total eligible accounts under Computation of Availability as the total eligible accounts number for the schedules instead of the total eligible accounts calculation for the schedules.

A payor category limit may limit the total eligible accounts field for that payor category. The total eligible accounts field for the payor is generally not higher than the limit amount. To display the limit for a payor category, a footnote (or other symbol) may be included in the Computation of Collateral page of the BBC to indicate the limit. The actual value of the total eligible accounts may be displayed in that field even if a limit is applied. When applicable, the limit amount may be used in the calculation of total eligible accounts under Computation of Availability as the total eligible accounts number for the payor category instead of the total eligible accounts calculation for the payor. A rollup option may be provided in the schedules dropdown for a payor limit. Limits may be applied to an individual payor or the rollup. The limit may affect the total eligible accounts for the payor(s). The total eligible accounts for the payor in the limit generally cannot be higher than the limit amount. To display the limit for a payor, a footnote (or other symbol) in the Computation of Collateral page of the BBC may be included. The actual value of the total eligible accounts may be displayed in that field even if a limit is applied. When applicable, the limit amount may be used in the calculation of total eligible accounts under Computation of Availability as the total eligible accounts number for the schedules that the payor belongs to instead of the total eligible accounts calculation for the schedules.

A limit to an adjustment field may limit the dollar amount that may be entered into the adjustment field. If the adjustment field selected is typically added to availability, the limit may be the lesser of the customer input and the limit. In other words, for all the adjustment fields that are added to the total availability, their limit means that the value cannot be greater than the limit. In this example, the limit is the ceiling. If the adjustment field is typically subtracted from availability the limit may be the greater of the customer input and the limit. In other words, for all the adjustment fields that are subtracted from the total availability, their limit means that their value has to be the limit or higher. In this example, the limit is a floor. To display an adjustment field, a footnote (or other symbol) in the Computation of Collateral page of the BBC may be included to the adjustment field. A user may enter an amount in the adjustment field where the limit may be applied in the calculation of net adjustments, eligible accounts and/or total eligible accounts.

Limits may be applied in the Computation of Availability area in various situations. For example, a limit may be applied to a reserve and/or collateral to limit the dollar amount that may be entered in the reserve/collateral field. A reserve limit may prevent the amount in the reserve from going below the amount of the limit. In this example, the reserve amount cannot be less than the limit. A collateral limit may prevent the amount in the collateral from going above the amount on the limit. In this example, the collateral amount cannot be greater than the limit. To display a reserve or collateral limit, a footnote (or other symbol) in the Computation of Availability page of the BBC template may be applied. A user may enter an amount in the reserve/collateral field where the limit may be applied in the calculation of net adjustments, eligible accounts and/or total eligible accounts. In addition, a limit for over-availability may be created under Computation of Loan.

At step 516, loan data may be computed. A customer may enter computation of loan data where a new loan balance and/or remaining availability may be calculated for the customer. FIG. 17 is an exemplary interface for displaying a Computation of Loan page for generating a funding request, according to an embodiment of the present invention. The loan identifier 1710 of the loan for the funding request may be displayed. Computation of Loan may involve obtaining loan balance 1720 and gross collections 1722, which may be received from an RTS feed or other data source, where these fields may be pre-populated. Adjustments 1724 may be entered, which may affect the adjusted loan balance field. If an increase loan balance button is selected at 1726, the amount may be added to the loan balance. If a decrease loan balance button is selected at 1726, the amount may be subtracted. Other adjustments may be applied. An adjusted loan balance value 1728 may be calculated, which may involve adding the loan balance, gross collections and adjustments. An availability before loan request 1730 may be calculated, which may involve subtracting the adjusted loan balance value from the net availability value where the net availability value may be obtained from the Computation of Availability page. A customer may enter a loan request amount 1732, which should not be higher than the amount calculated in the availability before loan request amount. However, the amount may be higher when an over-availability is applied (or based on other conditions). New loan balance 1734 may then be calculated by adding the adjusted loan balance and the loan request amount. Remaining availability 1736 may be calculated by subtracting the new loan balance from the net availability amount. This field should not be negative unless an over-availability exists or other condition applies. If an over-availability exists, a footnote (or other symbol) may be created on this field to display the amount of the over-availability.

Over-availabilities may be applied at the Computation of Loan area. An over-availability may allow the remaining availability field to go to a negative value and may be reflected as a footnote (or other symbol) in the computation of loan page. In addition, over-availability may also have a limit, floor or other constraint.

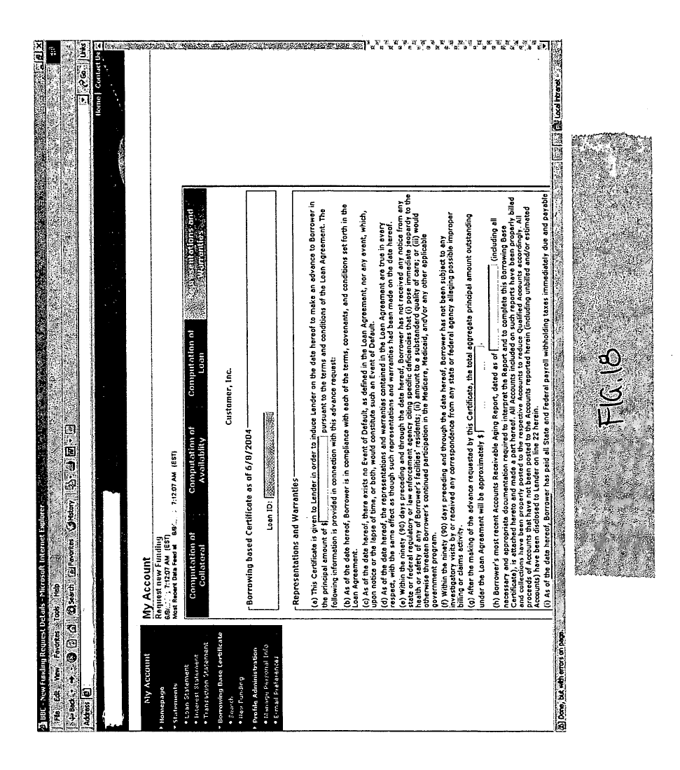

At step 518, representations and/or warranties may be presented to the borrower for acceptance and/or completion. A customer may select and/or enter data into the representations and warranties page, such as a loan amount, a new loan balance, and a billed accounts balance (per aging dated). The type of data that may be entered is unlimited due to the ability to customize the template in accordance with the representations and warranties from the loan contract. FIG. 18 is an exemplary interface for displaying a Representations and Warranties page for generating a funding request, according to an embodiment of the present invention. The clauses of legal data (and/or other data) selected in the BBC template, discussed above in connection with step 322, are displayed. The RM or other user may enter setup data, which may include contact name, contact title, company name, date of loan agreement, borrower name, lender name, and/or other data.

At step 520, rollup pages may be accessed. A rollup view of the computation of collateral and/or computation of availability pages may be displayed to the user. For example, when creating a rollup view of computation of collateral, the liquidity factor may be displayed or not based on the liquidity factor of the individual payor categories. If the individual payor categories have the same liquidity factor, it may be displayed on the rollup. When the liquidity factor is the same across similar payors, adjustment fields may be created at the rollup level before and after liquidity factor. When creating the rollup view of computation of collateral, the liquidity factor may be displayed or not, based on the liquidity factor of the individual payor categories. If the individual payor categories have different liquidity factors, it will generally not be displayed on the rollup. When the liquidity factor is different across similar payors, adjustment fields may be created at the rollup level after the liquidity factor.

For example, when creating the rollup view of computation of availability, the advance rate may be displayed or not, based on the advance rate of the individual schedules. If the individual schedules have the same advance rate, it may be displayed on the rollup. When the advance rate is the same across similar payors, reserves and collaterals may be created at the rollup level before and after the advance rate. When creating the rollup view of the computation of availability, the advance rate may be displayed or not based on the advance rate of the individual schedules. If the individual schedules have different advance rates, it will generally not be displayed on the rollup. When the advance rate is different across schedules, reserves and collaterals may be created at the rollup level after the advance rate.

At step 522, a review and approval process may be conducted. The review process may involve PA review and/or RM review. Other participants may also approve the funding request. The PA may review the request online and accept or reject the funding request. If approved, the RM may view the PA's comments and reject or approve the funding request. If approved by the PA and the RM, notification (e.g., email notification) may be sent to the customer (or other authorized agent) in step 532. The review can be conducted sequentially by the PA and then the RM, or concurrently.

If the funding request is rejected, the PA and/or RM may notify the customer with reasons for the rejection and may identify various errors and provide comments or annotations for the customer where applicable, at step 524. The PA and/or RM may also provide the customer with direct links (sometimes referred to as “hot links”) to the particular field(s) in the BBC template that were the source of the error(s). At step 526, the customer may review the errors and comments. In response, the customer may make corrections where appropriate, such as by editing the invalid fields of the BBC template. If the customer disagrees that a change is required, the customer may discuss the error with the RM or PA, or challenge the findings of the PA or RM, at step 528. At step 530, the customer may resubmit the funding request for PA and RM approval. If the RM and/or the PA approve the funding request, a notification may be sent to the customer at step 532. While the process illustrated in FIG. 5 discloses certain steps performed in a particular order, it should be understood that the present invention may be practiced by adding one or more steps to the process, omitting steps within the process and/or altering the order in which one or more steps are performed.

According to an embodiment of the invention, the systems and processes may be implemented on any general or special purpose computational device, either as a standalone application or applications, or even across several general or special purpose computational devices connected over a network and as a group operating in a client-server mode. According to another embodiment of the invention, a computer-usable and writeable medium having a plurality of computer readable program code stored therein may be provided for practicing the process of the present invention. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present invention may comprise computer readable program code in the form of functional instructions stored in the computer-usable medium such that when the computer-usable medium is installed on the system or systems, those components cause the system to perform the functions described. The computer readable program code for the present invention may also be bundled with other computer readable program software. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to an embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

While the invention has been particularly shown and described within the framework of borrowing base certificate administration, it will be appreciated that variations and modifications can be effected by a person of ordinary skill in the art without departing from the scope of the invention. Furthermore, one of ordinary skill in the art will recognize that such processes and systems do not need to be restricted to the specific embodiments described herein.

what is claimed is:

1. A computer implemented method for borrowing base management, the computer implemented method comprising the steps of:
generating a borrowing base template for a loan wherein the borrowing base template is customized for a user by segmenting the loan into a plurality of schedules and assigning each schedule a corresponding advance rate that is applied to eligible collateral;
making the borrowing base template accessible to the user through an online interface;
receiving funding request data from the user through the online interface; and
generating a funding request for the user with the borrowing base template.

2. The method of claim 1, wherein the step of generating a borrowing base template further comprises the step of:
identifying one or more payor categories for each schedule.

3. The method of claim 1, wherein the step of generating a borrowing base template further comprises:
identifying one or more adjustment fields; and
identifying a liquidity factor.

4. The method of claim 1, wherein the step of generating a borrowing base template further comprises the step of:
identifying an over-availability for the loan.

5. The method of claim 1, wherein the step of generating a borrowing base template further comprises the step of:
identifying one or more limits for one or more features of the loan.

6. The method of claim 1, wherein the step of generating a borrowing base template further comprises the step of:
selecting one or more representations and warranties for the borrowing base template.

7. The method of claim 1, wherein the step of generating a funding request further comprises the step of:
computing collateral data for each payor associated with a schedule.

8. The method of claim 1, wherein the step of generating a funding request further comprises the step of:
computing availability data for each payor associated with a schedule.

9. The method of claim 1, wherein the step of generating a funding request further comprises the step of:
computing loan balance data.

10. The method of claim 1, wherein the funding request is reviewed by a reviewer wherein the reviewer identifies errors for user response.

11. The method of claim 1, further comprising the step of sending to the user written comments relating to a rejection of the funding request.

12. A computer implemented system for borrowing base management, the computer implemented system comprising:
a template module for generating a borrowing base template for a loan wherein the borrowing base template is customized for a user by segmenting the loan into a plurality of schedules and assigning each schedule a corresponding advance rate that is applied to eligible collateral;
an online interface for making the borrowing base template accessible to the user and receiving funding request data from the user; and
a funding request module for generating a funding request for the user with the borrowing base template.

13. The system of claim 12, further comprising:
a payor module for identifying one or more payor categories for each schedule.

14. The system of claim 12, further comprising:
an adjustment fields module for identifying one or more adjustment fields and identifying a liquidity factor.

15. The system of claim 12, wherein an over-availability is identified for the loan.

16. The system of claim 12, further comprising:
a limits module for identifying one or more limits for one or more features of the loan.

17. The system of claim 12, further comprising:
a representations and warranties module for selecting one or more representations and warranties for the borrowing base template.

18. The system of claim 12, further comprising:
a collateral module for computing collateral data for each payor associated with a schedule.

19. The system of claim 12, further comprising:
an availability module for computing availability data for each payor associated with a schedule.

20. The system of claim 12, further comprising:
a loan module for computing loan balance data.

21. The system of claim 12, wherein the funding request is reviewed by a reviewer wherein the reviewer identifies errors for user response.

22. The system of claim 12, further comprising a notification module that sends to the user written comments relating to a rejection of the funding request.

23. At least one processor readable carrier for storing a computer program of instructions configured to be readable by at least one processor for instructing the at least one processor to execute a computer process for performing the method as recited in claim 1.

24. At least one signal embodied in at least one carrier wave for transmitting a computer program of instructions configured to be readable by at least one processor to execute a computer process for borrowing base management, the computer process comprising:
template generating means for generating a borrowing base template for a loan wherein the borrowing base template is customized for a user by segmenting the loan into a plurality of schedules and assigning each schedule a corresponding advance rate that is applied to eligible collateral;
means for making the borrowing base template accessible to the user through an online interface;
receiving means for receiving finding request data from the user through the online interface; and
request generating means for generating a funding request for the user.
